(19) United States
(12) Patent Application Publication
(10) Pub. No.: US 2026/0300867 A1
(43) Pub. Date: Oct. 1, 2026

(54) INFORMATION PROCESSING DEVICE, INFORMATION PROCESSING METHOD, AND RECORDING MEDIUM

(71) Applicant: NEC Corporation, Tokyo (JP)

(72) Inventor: Wataru ITONAGA, Toyota (JP)

(73) Assignee: NEC Corporation, Tokyo (JP)

(21) Appl. No.: 19/565,674

(22) Filed: Mar. 13, 2026

(30) Foreign Application Priority Data
Mar. 26, 2025 (JP) 2025-050926

(51) Int. Cl. G06Q 10/0631; G06Q 50/26

(52) U.S. Cl. CPC G06Q 10/06316; G06Q 50/265

(57) ABSTRACT

In order to prevent spread of damage due to a response delay in a case where a disaster occurs, a processor of an information processing device decomposes a job described in a manual into a plurality of tasks. The processor determines a solution method for each of the plurality of tasks. The outputs an instruction for executing each of the tasks based on the determined solution method.

### INCORPORATION BY REFERENCE

This application is based upon and claims the benefit of priority from Japanese Patent Application 2025-050926, filed on Mar. 26, 2025, the disclosure of which is incorporated herein in its entirety by reference.

### TECHNICAL FIELD

The present disclosure relates to a technique for preventing spread of damage due to a response delay in a case where a disaster occurs.

### BACKGROUND ART

When a disaster occurs, administrative personnel are required to act in accordance with a disaster manual. However, since the disaster is a rare event that rarely occurs, even in a situation where staff other than staff in charge of disaster prevention respond, u may be difficult to take a quick and appropriate response because most of the staff do not grasp the manual.

For example, Patent Document 1 proposes a system that improves job efficiency by utilizing a natural language analysis model using AI, retrieving knowledge data based on request information from a user, and generating and transmitting appropriate answer information.

Patent Document 1: Japanese Patent No. 7504531

### SUMMARY

One object of the present disclosure is to prevent spread of damage due to a response delay when a disaster occurs.

According to an example aspect of the present invention, there is provided an information processing device including:
at least one first memory configured to store instructions; and
at least one first processor configured to execute the instructions to:
decompose a job described in a manual into a plurality of tasks;
determine a solution method for each of the plurality of tasks; and
output an instruction for executing each of the tasks based on the determined solution method.

According to another example aspect of the present invention, there is provided an information processing method including:
decomposing, by a computer, a job described in a manual into a plurality of tasks;
determining, by the computer, a solution method for each of the plurality of tasks; and
outputting, by the computer, an instruction for executing each of the tasks based on the determined solution method.

According to still another example aspect of the present invention, there is provided a program for causing a computer to execute processing including:
decomposing a job described in a manual into a plurality of tasks;
determining a solution method for each of the plurality of tasks; and
outputting an instruction for executing each of the tasks based on the determined solution method.

### Effect

According to the present disclosure, it is possible to prevent the spread of damage due to the response delay when the disaster occurs.

### BRIEF DESCRIPTION OF THE DRAWINGS

FIG. 1 is an example of a schematic configuration of a countermeasure support system to which an information processing device of the present disclosure is applied;

FIG. 2 is a diagram for explaining an example of an allocation process;

FIG. 3 is a block diagram illustrating an example of a hardware configuration of a countermeasure support device;

FIG. 4 is a block diagram illustrating an example of a hardware configuration of a job processing device;

FIG. 5 is a block diagram illustrating an example of a hardware configuration of a terminal device;

FIG. 6 is a diagram illustrating a specific example of the countermeasure support system according to the present disclosure;

FIG. 7 is a diagram illustrating an example of a functional configuration of the countermeasure support device;

FIG. 8 is a diagram illustrating an example of a functional configuration of the job processing device;

FIG. 9 is a diagram illustrating an example of a functional configuration of the terminal device;

FIG. 10 is a flowchart for explaining countermeasure support processing performed by the countermeasure support device;

FIG. 11 is a flowchart for explaining a job process performed by the job processing device;

FIG. 12 is a flowchart for explaining manual processing performed by the terminal device;

FIG. 13 is a view for explaining an example of task extraction and discrimination of execution entities;

FIG. 14 is a view illustrating a prompt and an output example of a countermeasure AI model;

FIG. 15 is a view illustrating the prompt and an output example of the countermeasure AI model when a delay is detected;

FIG. 16 is a block diagram illustrating a functional configuration of another countermeasure support device; and

FIG. 17 is a flowchart of processing by the another countermeasure support device.

### EXAMPLE EMBODIMENTS

Hereinafter, example embodiments of the present disclosure will be described with reference to the drawings.

### First Example Embodiment

A catastrophic disaster that costs more human lives is a rare event that occurs less frequently. In an administrative district where such a rare event has occurred, not only staff in charge of disaster prevention but also many people outside the administrative district are involved in disaster response. However, even if there is a manual for disaster countermeasures in the administrative district, not all people involved in the disaster response are familiar with the manual and have been sufficiently trained according to the manual. In addition, under a situation where the degree of tension is high when the disaster occurs, there is a case where it is difficult to appropriately determine a countermeasure procedure and a work load on each person involved in the disaster response.

In the present disclosure, when such an event occurs, content and a procedure that can be performed by a system and content and a procedure that are manually performed are discriminated from among countermeasure procedures described in the existing manual, cooperation between the system and a human is optimized, and a work load of the human is mitigated. In addition, in the present disclosure, content to be performed subsequently and the order thereof are adjusted in accordance with a notification from the system and the human.

### Schematic Configuration

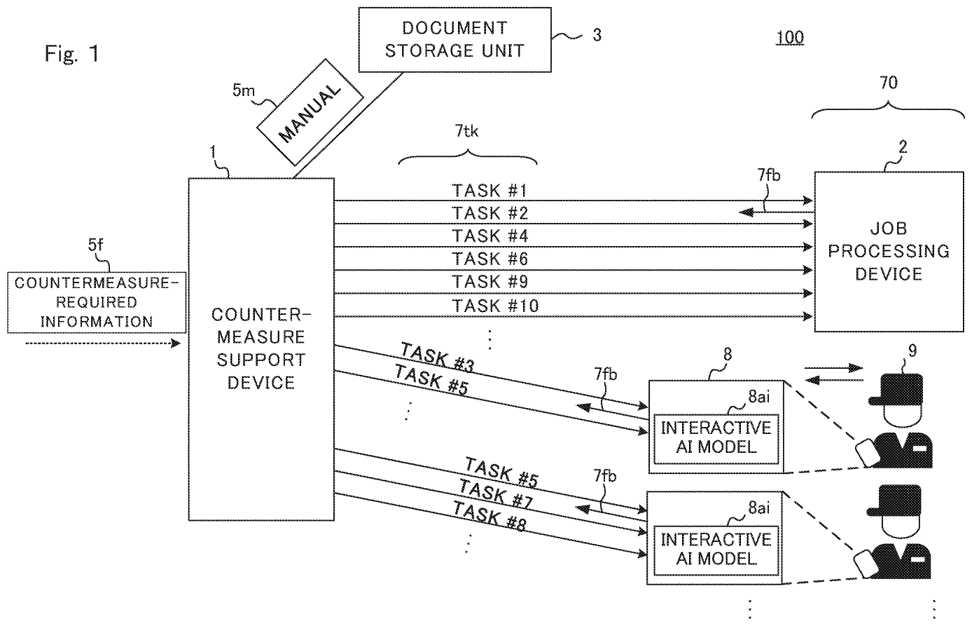

FIG. 1 is an example of a schematic configuration of a countermeasure support system to which an information processing device of the present disclosure is applied. A countermeasure support system 100 is a system that is introduced in an administrative district and supports job of staff in charge of disaster prevention and the like (hereinafter, referred to as “workers 9”) who are in charge of evacuation shelter management and stockpiling in the event of a disaster. In response to detection of the occurrence of an event (hereinafter, referred to as “countermeasure-required information 5f”), the countermeasure support system 100 generates a workflow based on an existing manual 5m to prevent spread of damage due to a response delay when the disaster occurs. In the present disclosure, the countermeasure support system 100 discriminates entities (hereinafter, referred to as “execution entities 70”) that execute countermeasure pieces of work constituting the generated workflow, and optimizes a process for each of the execution entities 70. The execution entities 70 in the present disclosure include a “system” and a “human”.

The countermeasure support system 100 includes a countermeasure support device 1, a job processing device 2, and a terminal device 8. The countermeasure support device 1 is communicably connected to each of the job processing device 2 and the terminal device 8 via a network such as the Internet. In the present disclosure, the job processing device 2 corresponds to the “system” as the execution entity 70, and a series of processes related to a countermeasure taken by the job processing device 2 corresponds to a “system process”. The worker 9 corresponds to the “human” as the execution entity 70, and a series of work conducted by the worker 9 corresponds to a “manual process”.

The countermeasure support device 1 is an information processing device that processes, stores, and transmits and receives various types of data, and mainly performs processing related to administrative support. When occurrence of a disaster requiring administrative support in an administrative district is detected from the countermeasure-required information 5f, the countermeasure support device 1 identifies content of countermeasures (hereinafter, referred to as “tasks 7tk”) for each of the system process and the manual process, and optimizes the execution order thereof. That is, the countermeasure support device 1 acquires the manual 5m, referred to in the disaster countermeasures, from a document storage unit 3, analyzes the manual 5m, and identifies the tasks. In addition, the countermeasure support device 1 allocates the identified tasks to the execution entities 70 of either the system process or the manual process, and optimizes the execution order in each of the processes. Then, the countermeasure support device 1 causes the job processing device 2 to execute tasks in the system process, and notifies the terminal device 8, used by the worker 9 such as staff of the administrative district, of tasks in the manual process.

The document storage unit 3 is a storage unit that can be accessed by the countermeasure support device 1, and stores document data in which work content and a work procedure, which are created by the worker 9 or the like and used for supporting a region controlled by the administrative district, are described. The document storage unit 3 may be an external storage device connected by wired or wireless communication, or may be a storage device provided inside the countermeasure support device 1.

The job processing device 2 is an information processing device that processes, stores, and transmits and receives various types of data, and is mainly a device that performs various job processes related to jobs at a normal time. In order to perform various job processes, the job processing device 2 has functions of performing the various job processes, such as an information management process of managing information on contact addresses of staff related to administrative operation, external organizations related to administrative jobs, and the like, a process of transmitting and receiving electronic mails used for making contact with related departments, and a process of creating slips and placing orders to purchase supplies. The countermeasure support device 1 may include the functions of the job processing device 2, and the countermeasure support device 1 and the job processing device 2 may be as a single device.

When tasks are received from the countermeasure support device 1, the job processing device 2 executes job processes according to the received tasks. The countermeasure support device 1 is notified of an execution result for each of the tasks as feedback 7fb.

The worker 9 has the terminal device 8 capable of receiving the task from the countermeasure support device 1. The terminal device 8 is a portable terminal such as a smartphone or a tablet that performs processing, storage, transmission, and reception of various types of data, and is mainly used for administrative job communication or the like at the normal time. In the present disclosure, the terminal device 8 owned by each of the workers 9 includes an interactive AI model 8ai.

When the reception of the task from the countermeasure support device 1 is detected, the interactive AI model 8ai can issue an instruction to the worker 9 and have a conversation with the worker 9 in the process of work of the worker 9 related to the instruction. With respect to the interactive AI model 8ai, the worker 9 reports a problem noticed in the process of the work, and asks a question for performing the work, in addition to sending a completion notification indicating that the work has been completed. For example, as the problem, the countermeasure support device 1 is notified of content of a dialogue, such as a current state report in which supplies are insufficient or a route is blocked, as the feedback 7fb. In addition, the countermeasure support device 1 is notified of, as the question, a dialogue, such as how to handle equipment, checking of a safe or shortest route to a destination, and checking of necessary personnel, for executing the work.

The worker 9 does not need to distinguish whether the content to be notified is the problem or the question. In addition, the notification is not limited to a character input and a voice input by the worker 9, and may be an image or a moving image obtained by activating a camera during the interaction with the interactive AI model 8ai and capturing the periphery of the worker 9.

In the countermeasure support system 100, under a tense situation when the disaster occurs, each of the workers 9 can act in accordance with an instruction from the terminal device 8 without performing work such as identifying the manual 5m and checking a countermeasure. Therefore, each of the workers 9 can promptly take action as a disaster countermeasure. In addition, the countermeasure support device 1 identifies the manual 5m to check content and a procedure of the countermeasure, further discriminates between the system process and the manual process, and instructs only the task of the manual process to each of the workers 9. As a result, a limited number of the workers 9 can concentrate on only the task, and can quickly perform the initial operation immediately after the occurrence of the disaster. In addition, the notification causes the countermeasure support device 1 to review the work procedure including the necessity of an additional task. Therefore, it is possible to reduce confusion during the disaster countermeasure and to stabilize the execution of work.

Regarding a rare event having a low occurrence frequency, it is difficult for the worker 9 and the like to be sufficiently trained for the countermeasure in advance. Even in such a case, according to the countermeasure support system 100, it is possible to prevent the spread of the damage due to the delay of the disaster response.

### Allocation Process

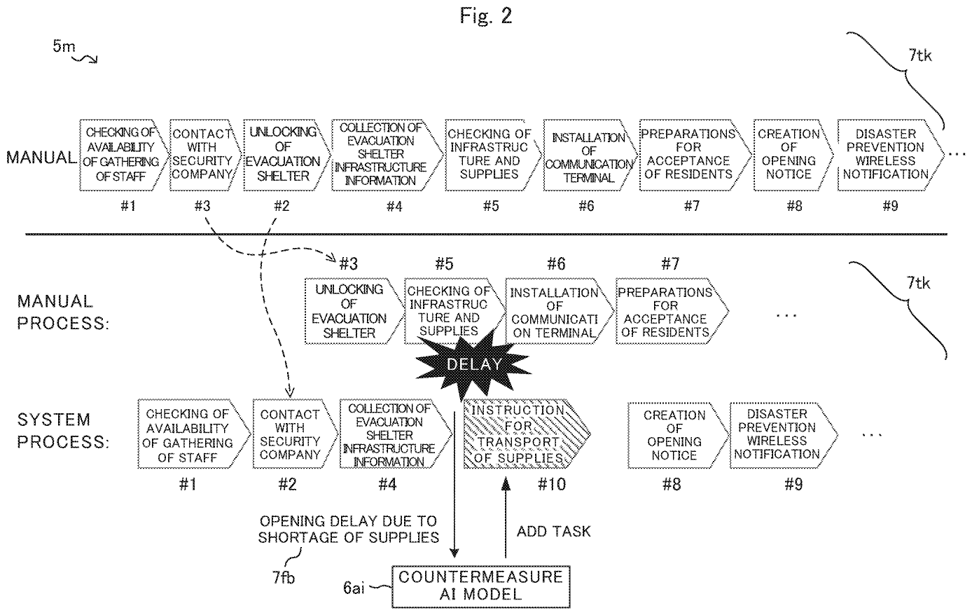

Next, an example of an allocation process of allocating the execution entities 70 of the tasks to the system process and the manual process will be described with reference to FIG. 1 and FIG. 2. In FIG. 1 and FIG. 2, tasks to be executed are indicated by the tasks 7tk. Hereinafter, #n (n=natural number) may be assigned to each of the tasks 7tk as an identification number to allow identification and indicate the execution order of the task 7tk.

FIG. 2 is a diagram for explaining an example of the allocation process. In this example, by analyzing the manual 5m, a case is illustrated in which a task #1 to a task #10 can be identified as the tasks 7tk to be performed until an evacuation shelter is opened and preparations for accepting residents are made in response to the occurrence of the disaster. The countermeasure support device 1 allocates each of the tasks #1 to #10 to either the manual process or the system process, and predicts an execution timing of the task allocated in each process.

In FIG. 2, the manual 5m describes various countermeasure items. In the countermeasure support device 1, a countermeasure AI model 6ai reads and analyzes the manual 5m, extracts the countermeasure items, and identifies the extracted countermeasure items as the individual tasks 7tk. Then, the execution order of the plurality of extracted tasks 7tk is optimized. In this example, in the order described in the manual 5m, “checking of availability of gathering of staff” is identified as the task #1, “unlocking of evacuation shelter” is identified as the task #3, “contact with security company” is identified as the task #2, “collection of evacuation shelter infrastructure information” is identified as the task #4, “checking of infrastructure and supplies” is identified as the task #5, “installation of communication terminal” is identified as the task #6, “preparations for acceptance of residents” is identified as the task #7, “creation of opening notice” is identified as the task #8, and “disaster prevention wireless notification” is identified as the task #9. The execution order is indicated by the identification numbers of the tasks, and in this example, “unlocking of evacuation shelter” and “contact with security company” are executed in order different from the order of being described in the manual 5m due to optimization.

The countermeasure AI model 6ai further allocates the task 7tk, which is work of the worker 9, to the manual process based on content of each of the countermeasure items, and allocates the task 7tk, which can be processed by the job processing device 2, to the system process. In addition, the countermeasure AI model 6ai predicts the execution timing of the task in each process in consideration of the cooperation between the manual process and the system process.

In the example of FIG. 2, in the initial optimization, the task #3, the task #5, the task #6, and the task #7 are set in this order in the manual process. In the system process, the task #1, the task #2, the task #4, the task #8, and the task #9 are set in this order. In the optimized execution order of the tasks, the countermeasure AI model 6ai predicts the execution timing to start each of the tasks 7tk in such a way that the countermeasures are performed in cooperation between the manual process and the system process. For example, the countermeasure AI model 6ai determines the execution timing of each task such that the task #1 is ended in the system process and the task #2 is started until the worker 9 starts “unlocking of evacuation shelter” of the task #3 immediately after the disaster occurs. This makes it possible to collect information on infrastructure of the evacuation shelter notified from the worker 9.

In addition, the number of the workers 9 who perform each task in the manual process may be optimized based on the feedback 7fb regarding “checking of availability of gathering of staff” of the task #1, and the worker 9 may be associated with worker identification information for identifying the worker 9. For example, when two workers 9 are specified in the task #5, the task #5 may be transmitted to the terminal device 8 of each of the two workers 9 identified by the worker identification information. The same applies to other tasks in the manual process.

Further, when the feedback 7fb is received, the countermeasure AI model 6ai generates a new task as necessary based on content of the feedback 7fb, and adjusts each process subsequent to the received feedback 7fb. For example, it is assumed that the feedback 7fb (FB #5) sent from the worker 9 in charge of “checking of infrastructure and supplies” of the task #5 indicates an opening delay due to shortage of supplies. In this case, the countermeasure AI model 6ai generates the new task #10 indicating an instruction for transport of the identified supplies, and adjusts the system process in such a way that the task #10 is prioritized. In this example, the worker 9 only needs to perform the feedback 7fb, and does not need to arrange for the transport of supplies by himself/herself. The countermeasure AI model 6ai adjusts the tasks of the respective processes in consideration of the cooperation between the manual process and the system process in accordance with the content of the feedback 7fb received from each of the job processing device 2 and the terminal device 8, and optimizes the execution timing of each of the tasks.

### Hardware Configuration

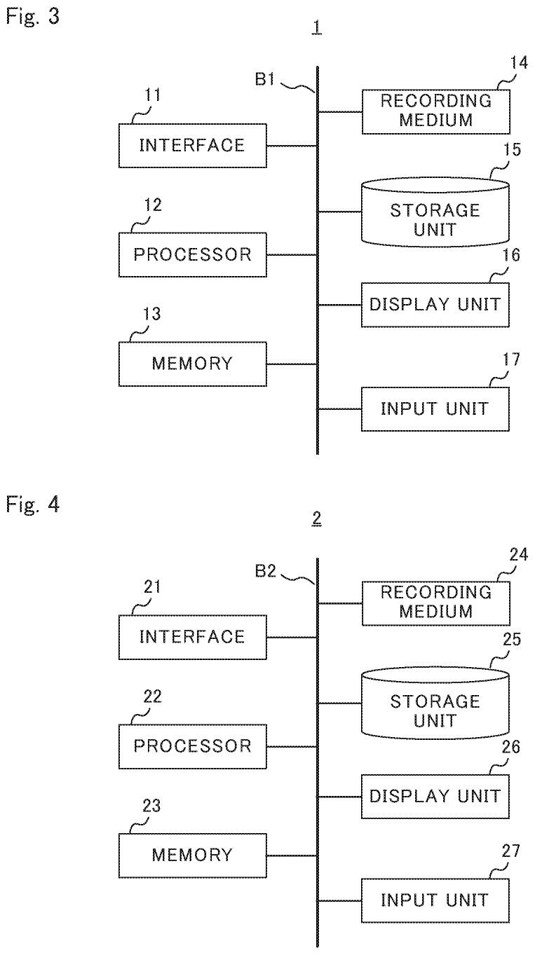

FIG. 3 is a block diagram illustrating an example of a hardware configuration of the countermeasure support device. As illustrated in FIG. 3, the countermeasure support device 1 includes an interface 11, a processor 12, a memory 13, a recording medium 14, a storage unit 15, a display unit 16, and an input unit 17. The interface 11, the processor 12, the memory 13, the recording medium 14, the storage unit 15, the display unit 16, and the input unit 17 are connected to a bus B1 and can communicate with each other.

The interface 11 exchanges data with the job processing device 2, the terminal device 8, and the like. The interface 11 is used to transmit the tasks to the job processing device 2 and the terminal device 8 via the network and receive the feedback 7fb for each of the tasks. The interface 11 is also used in a case where the countermeasure support device 1 exchanges data with a predetermined device connected via the network or the like. For example, the case is a case where the predetermined device corresponds to the document storage unit 3.

The processor 12 is a computer such as a Central Processing Unit (CPU), and controls the entire countermeasure support device 1 by executing a program prepared in advance. As the processor 12, it is possible to use a CPU, a Graphics Processing Unit (GPU), a Digital Signal Processor (DSP), a Micro Processing Unit (MPU), a Floating Point Unit (FPU), a Physics Processing Unit (PPU), a Tensor Processing Unit (TPU), a quantum processor, a microcontroller, a combination of these, or the like.

The memory 13 includes a Read Only Memory (ROM), a Random Access Memory (RAM), and the like. The memory 13 stores a program executed by the processor 12. The memory 13 is also used as a working memory during execution of various types of processing by the processor 12.

The recording medium 14 is a non-volatile and non-transitory recording medium such as a disk-shaped recording medium or a semiconductor memory, and is attachable to and detachable from the countermeasure support device 1. The recording medium 14 records various programs to be executed by the processor 12. When the countermeasure support device 1 executes processing of analyzing a cognitive function, the program recorded in the recording medium 14 is loaded into the memory 13 and executed by the processor 12.

The storage unit 15 stores various types of data related to processing executed by the countermeasure support device 1. The storage unit 15 may implement the document storage unit 3 inside the countermeasure support device 1. The display unit 16 displays a predetermined image by, for example, a Liquid Crystal Display (LCD). The input unit 17 is a keyboard, a mouse, a touch panel, or the like, and is used by an administrator who manages the countermeasure support device 1.

FIG. 4 is a block diagram illustrating an example of a hardware configuration of the job processing device. As illustrated in FIG. 4, the job processing device 2 includes an interface 21, a processor 22, a memory 23, a recording medium 24, a storage unit 25, a display unit 26, and an input unit 27. The interface 21, the processor 22, the memory 23, the recording medium 24, the storage unit 25, the display unit 26, and the input unit 27 are connected to a bus B2 and can communicate with each other.

The interface 21 exchanges data with the countermeasure support device 1. The interface 21 is used to receive the task from the countermeasure support device 1 via the network and transmit a result of execution of the task as the feedback 7fb to the countermeasure support device 1. The interface 21 is also used in a case where the job processing device 2 exchanges data with a predetermined device connected via the network or the like. For example, the case is a case where the worker 9 operates the job processes of the job processing device 2 via the connected terminal device 8.

The processor 22 is a computer such as a CPU, and controls the entire job processing device 2 by executing a program prepared in advance. As the processor 22, it is possible to use a CPU, a GPU, a DSP, an MPU, an FPU, a PPU, a TPU, a quantum processor, a microcontroller, a combination of these, or the like.

The memory 23 includes a ROM, a RAM, or the like. The memory 23 stores a program executed by the processor 22. The memory 23 is also used as a working memory during execution of various types of processing by the processor 22.

The storage unit 25 stores various types of data related to processing executed by the job processing device 2. The data stored in the storage unit 25 includes data, a database, and the like dedicated to the job processes executed by the job processing device 2. The display unit 26 displays a predetermined image by, for example, an LCD. The input unit 27 is a keyboard, a mouse, a touch panel, or the like, and is used by an administrator who manages the job processing device 2.

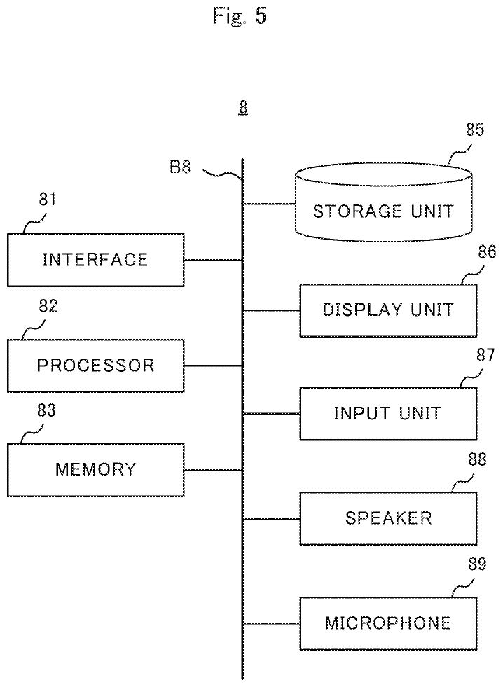

FIG. 5 is a block diagram illustrating an example of a hardware configuration of the terminal device. As illustrated in FIG. 5, the terminal device 8 includes an interface 81, a processor 82, a memory 83, a storage unit 85, a display unit 86, an input unit 87, a speaker 88, and a microphone 89. The interface 81, the processor 82, the memory 83, the storage unit 25, the display unit 86, the input unit 87, the speaker 88, and the microphone 89 are connected to a bus B8 and can communicate with each other.

The interface 81 exchanges data with the countermeasure support device 1. The interface 81 is used to receive the task from the countermeasure support device 1 via the network and transmit a result of execution of the task by the worker 9 as the feedback 7fb to the countermeasure support device 1. The interface 81 is also used in a case where the terminal device 8 is connected to the job processing device 2 via a network or the like to use a predetermined job process.

The processor 82 is a computer such as a CPU, and controls the entire job processing device 2 by executing a program prepared in advance. As the processor 82, it is possible to use a CPU, a GPU, a DSP, an MPU, an FPU, a PPU, a TPU, a quantum processor, a microcontroller, a combination of these, or the like.

The memory 83 includes a ROM, a RAM, or the like. The memory 83 stores a program executed by the processor 82. The memory 83 is also used as a working memory during execution of various types of processing by the processor 82.

The storage unit 85 stores various types of data related to processing executed by the terminal device 8 and various programs related to the present implementation. The display unit 86 displays a predetermined image by, for example, an LCD. The input unit 27 is a touch panel or the like, and is used by the worker 9 carrying the terminal device 8. The speaker 88 and the microphone 89 are appropriately used by the worker 9 or the interactive AI model 8ai.

### Countermeasure Support System

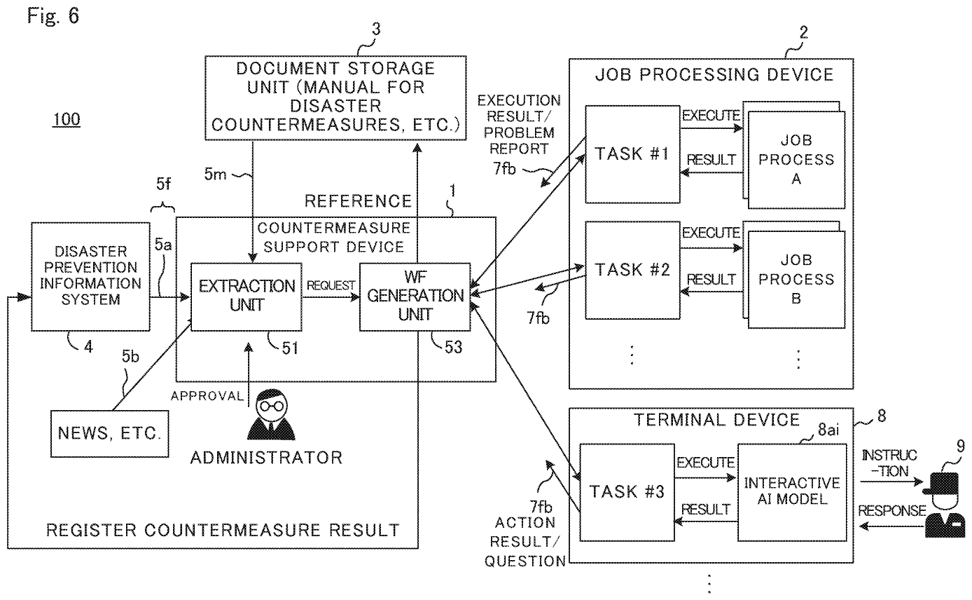

FIG. 6 is a diagram illustrating a specific example of the countermeasure support system according to the present disclosure. In FIG. 6, the countermeasure support system 100 detects the occurrence of the disaster, thereby activating countermeasure support processing performed by the countermeasure support device 1. In the example of FIG. 6, the countermeasure-required information 5f illustrated in FIG. 1 includes notification information 5a issued from a disaster prevention information system 4, disaster occurrence information 5b such as news, and the like. The notification information 5a corresponds to information issued from the disaster prevention information system 4 to notify the administrative district of the occurrence of the disaster in a case where the disaster occurs. The disaster occurrence information 5b corresponds to information such as news for causing the occurrence of the disaster to be informed via radio, public broadcast television, the Internet, or the like.

In the countermeasure support device 1, an extraction unit 51 extracts the relevant manual 5m from the document storage unit 3 based on content of the notification information 5a and the disaster occurrence information 5b. The extraction unit 51 notifies a workflow (WF) generation unit 53 of the acquired manual 5m to request for process generation. When the process generation is requested, it is desirable to present countermeasure-required information 5f (the notification information 5a, the disaster occurrence information 5b, and the like) and the manual 5m to the administrator and obtain approval for the validity of the extracted manual 5m. In addition, it is desirable to obtain, from the administrator, approval for generation and execution of a workflow for the countermeasure-required information 5f.

In response to the request from the extraction unit 51, the WF generation unit 53 extracts a plurality of the tasks 7tk from the manual 5m, and allocates each of the tasks 7tk to either the manual process or the system process. In addition, the WF generation unit 53 optimizes the execution order and the execution timings of the tasks in the respective processes while considering the cooperation between the manual process and the system process. Then, the WF generation unit 53 transmits the task in the manual process to the terminal device 8 of the worker 9 in charge, and transmits the task in the system process to the job processing device 2. Thereafter, the WF generation unit 53 receives the feedback 7fb for each of the tasks.

In the job processing device 2, for example, in a case where the task #1 is “checking of availability of gathering of staff”, a job process A for checking whether staff can be gathered is executed by the task #1, and a process of “checking of availability of gathering of staff” is performed. The job process A performs a process of sending an electronic mail in which text specified in the task #1 is set, using, for example, a mailing list with respect to the workers 9. The job process A notifies the task #1 of a reply including the availability of gathering of each of the workers 9. The task #1 transmits a result including data of a reply mail of each of the workers 9 received by the job process A to the countermeasure support device 1 as the feedback 7fb. For other tasks, the job processing device 2 similarly executes a job process related to each task, and the obtained result is transmitted to the countermeasure support device 1 as the feedback 7fb. By the feedback 7fb transmitted from the job processing device 2, problem reports, such as execution results of the job processes and errors, are aggregated in the countermeasure support device 1. Here, an instruction indicated by each of the tasks 7tk received from the countermeasure support device 1 may be described in a natural language, or may be described in cmd, PowerShell, or the like. In a case where the instruction is described in a natural language, the job processing device 2 may convert the instruction into a description in cmd, PowerShell, or the like and execute the converted description.

When the task is received, the terminal device 8 activates the interactive AI model 8ai provided in the terminal device 8 and gives an instruction regarding a disaster countermeasure to the worker 9. When an input of a character, a voice, an image (including a drawing), or a moving image by the worker 9 is detected after the instruction with respect to the worker 9, the interactive AI model 8ai notifies the task 7tk of the input of the worker 9 as a result of the instruction. Then, the task 7tk transmits the notified result as the feedback 7fb to the countermeasure support device 1. By the feedback 7fb from the terminal device 8, the countermeasure support device 1 is notified of an action result of the worker 9, a question from the worker 9, and the like.

For example, in a case where receiving the task #3 of “unlocking of evacuation shelter”, the terminal device 8 causes the interactive AI model 8ai to execute a conversation with the worker 9 in order to notify the worker 9 of an instruction specified in the task #3. When unlocking the specified evacuation shelter, the worker 9 notifies the interactive AI model 8ai of the fact that the evacuation shelter has been unlocked as a response to the instruction of the task #3. The interactive AI model 8ai notifies the response of the worker 9 as a result of executing the task #3. The task #3 transmits the result as the feedback 7fb (FB #3) to the countermeasure support device 1. Even in the middle of work for the task #3 of “unlocking of evacuation shelter”, the worker 9 may appropriately input a current state and the like including what has been noticed, what is predicted, and his/her own situation through a conversation with the interactive AI model 8ai. The response for each of the tasks 7tk may be sent a plurality of times. In this manner, pieces of the feedback 7fb from the respective workers 9 are aggregated in the countermeasure support device 1.

The WF generation unit 53 analyzes the received feedback 7fb of each of the tasks, and adjusts the manual process and the system process based on content of the feedback 7fb. In a case where a new countermeasure is required, the WF generation unit 53 refers to the manual or the like from the document storage unit 3, and performs adjustment such as addition of a task or change of the order of tasks.

In addition, the WF generation unit 53 registers a result of the countermeasure, taken with respect to the notification information 5a detected by the extraction unit 51, in the disaster prevention information system 4 by the feedback 7fb from each of the job processing device 2 and the terminal device 8. As the countermeasure result, information indicating a current state of a disaster-stricken area, information such as a place of the installed evacuation shelter, the number of accommodatable people, and the number of currently accommodated people, information such as the number of the workers 9 engaged in the countermeasures and the number of workers including volunteers, and the like obtained by the feedback 7fb may be indicated.

### Functional Configuration

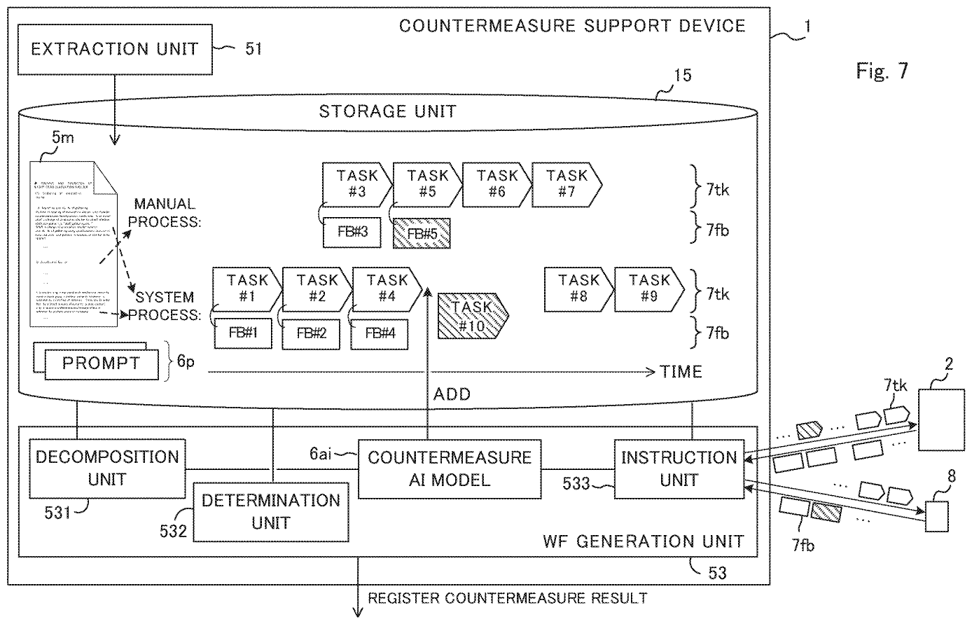

FIG. 7 is a diagram illustrating an example of a functional configuration of the countermeasure support device. In FIG. 7, the countermeasure support device 1 includes the extraction unit 51 and the WF generation unit 53 as functions. As described above, in a case of detecting the countermeasure-required information 5f, the extraction unit 51 acquires the manual 5m related to the countermeasure-required information 5f from the document storage unit 3, and requests the WF generation unit 53 to generate a workflow. The manual 5m is stored in the storage unit 15. In addition, the WF generation unit 53 decomposes the description of the manual 5m into the plurality of tasks 7tk, and allocates each of the tasks 7tk to the manual process and the system process. The WF generation unit 53 instructs the job processing device 2 or the worker 9 to execute each of the tasks 7tk at an optimized timing.

The WF generation unit 53 further includes a decomposition unit 531, a determination unit 532, an instruction unit 533, and the countermeasure AI model 6ai. The decomposition unit 531 inputs a prompt 6p to the countermeasure AI model 6ai to decompose a job described in the manual 5m into the plurality of tasks 7tk and extract the plurality of tasks 7tk. The decomposition unit 531 discriminates the execution entities 70 of the plurality of tasks 7tk and allocates each of the tasks to the related process. The determination unit 532 determines a solution method for each of the plurality of tasks 7tk based on an output of the countermeasure AI model 6ai. The countermeasure AI model 6ai may be used to determine the solution method.

When the workflow is generated in this manner, the instruction unit 533 instructs execution of the tasks 7tk by transmitting the tasks 7tk to the job processing device 2 and the terminal device 8 according to the execution order of the tasks 7tk. Then, in a case where the WF generation unit 53 determines that all the tasks described in the manual 5m have been completed, the WF generation unit 53 registers the countermeasure result in the disaster prevention information system 4. As the countermeasure result, information indicating the progress of content of the executed tasks or the like is registered in the disaster prevention information system 4 at a predetermined time interval, a predetermined countermeasure phase, or the like.

In a case where the received feedback 7fb indicates that an additional countermeasure is required, the instruction unit 533 generates a task for performing the countermeasure using the countermeasure AI model 6ai and adds the task to the storage unit 15. The instruction unit 533 stores the received feedback 7fb in the storage unit 15 in association with the identification number of the task 7tk. In FIG. 7, the feedback 7fb associated with the task 7tk is represented by FB #n (n is a natural number) using the identification number of the task 7tk.

The countermeasure AI model 6ai is a model trained by machine learning. The countermeasure AI model 6ai is trained in such a way that the plurality of tasks 7tk can be generated based on the description of the manual 5m with the input of the prompt 6p, and the solution method of each of the tasks 7tk can be determined. Further, the countermeasure AI model 6ai is trained to generate a new task and determine a solution method for the new task 7tk as well. In the example of FIG. 7, the task 7tk identified by the task #10 corresponds to the new task. The countermeasure AI model 6ai may generate one or more new tasks.

The WF generation unit 53 of the present disclosure can reduce a burden of decision making by the worker 9 such as the allocation of tasks and the determination of the execution order of tasks under tension due to the occurrence of the disaster. Since the tasks are allocated to be distinguished between the manual process and the system process, the worker 9 can concentrate on the execution of the tasks. In addition, since tasks allocated to the system process are executed in the optimal procedure, it is possible to reduce labor related to an operation of the job process performed by the worker 9. Therefore, the worker 9 can smoothly perform the given tasks.

In the above configuration, the decomposition unit 531 of the WF generation unit 53 is an example of a decomposition means of the present disclosure, the determination unit 532 is an example of a determination means of the present disclosure, and the instruction unit 533 is an example of an instruction means of the present disclosure. In addition, the countermeasure AI model 6ai is an example of a first machine learning model of the present disclosure.

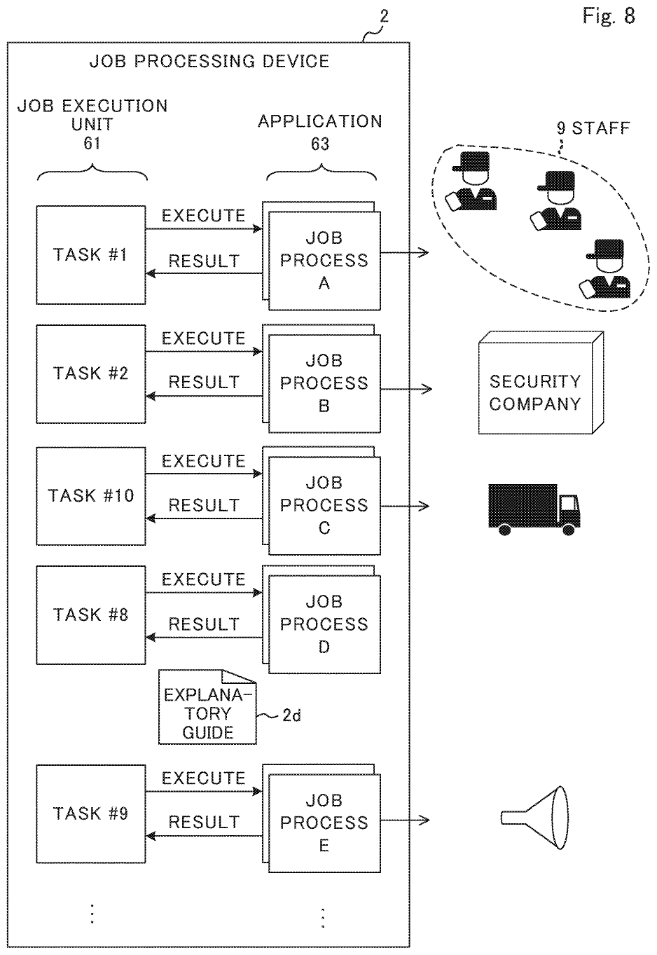

FIG. 8 is a diagram illustrating an example of a functional configuration of the job processing device. In FIG. 8, the job processing device 2 includes a job execution unit 61 and a plurality of applications 63 as functions. The job execution unit 61 is a processing unit that sequentially executes tasks received from the countermeasure support device 1. The job execution unit 61 executes the relevant application 63 according to a description of each of the tasks. The task may be described in a natural language or in a language executable by a computer. In a case where the task is described in a natural language, the job execution unit 61 executes processing by converting the task into a language executable by a computer. For example, a description in a natural language may be converted into cmd, PowerShell, or the like. The plurality of applications 63 are processing units that perform processing in a unit of job performed by one or more applications 63. The application 63 is activated in response to a call from the task, and outputs a result of execution of content of the task. The job execution unit 61 transmits the results received from the plurality of applications 63 to the countermeasure support device 1 as the feedback 7fb. As described above, the job execution unit 61 is an example of a job execution means of the present disclosure. The plurality of applications 63 are examples of an application of the present disclosure.

In addition, the job execution unit 61 executes the tasks in time series in accordance with the execution timings specified for the tasks, respectively. In the example of FIG. 8, for example, as the execution timings, “immediate execution” may be specified for the task #1, and the dependency relationship may be specified for the task #2 in such a way that the task #2 is “executed after the result of the task #1 is received”. In addition, the task #10 corresponds to the new task (FIG. 2 and FIG. 7) added according to the feedback 7fb (FB #5) for the task #5 of the manual process. In this case, “immediate execution” may be specified as the execution timing. In addition, in a case where the task #8 is a task to be executed in accordance with the progress of the manual process, “immediate execution” may be specified for the job processing device 2 by the instruction unit 533 of the countermeasure support device 1 controlling transmission of the task #8. Then, in a case where the task #9 is a task to be performed subsequent to the task #8, “execution after reception of the result of the task #8” may be specified. In this manner, the job execution unit 61 controls the execution of the tasks 7tk.

Through the control of the execution of the tasks 7tk described above, for example, “checking of availability of gathering of staff” is performed with respect to each of the workers 9 in the job process A by the task #1, and “contact with security company” is made in the job process B by the task #2. “Instruction for transport of supplies” is issued in a job process C by the added task #10. In addition, the task #8 executes a job process D, and an explanatory guide 2d is created and stored in the storage unit 25. The explanatory guide 2d may be included in a result of the job process D and transmitted to the countermeasure support device 1 as the feedback 7fb. Subsequently, the task #9 executes a job process E, and “disaster prevention wireless notification” is performed. At that time, content based on the explanatory guide 2d stored in the storage unit 25 may be included.

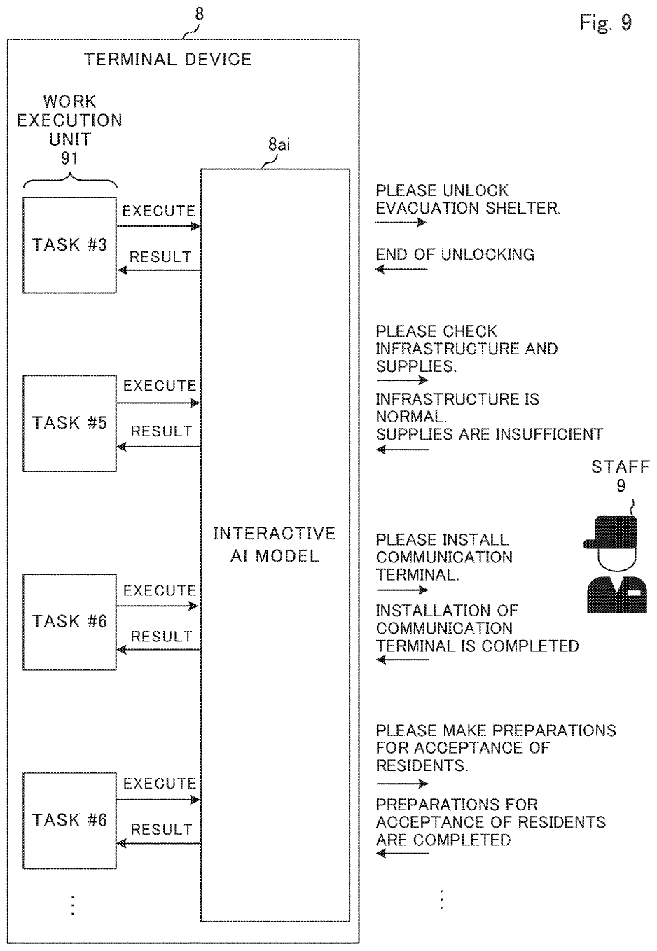

FIG. 9 is a diagram illustrating an example of a functional configuration of the terminal device. In FIG. 8, the terminal device 8 includes a work execution unit 91 and the interactive AI model 8ai as functions. The work execution unit 91 is a processing unit that sequentially executes the tasks 7tk received from the countermeasure support device 1. The work execution unit 91 activates the interactive AI model 8ai according to a description of each of the tasks 7tk to have a conversation with the worker 9. The task 7tk includes the description that enables the terminal device 8 to activate the interactive AI model 8ai and a prompt indicating content to be performed by the interactive AI model 8ai. When the task is a natural language, the work execution unit 91 may generate the description for activating the interactive AI model 8ai and the prompt indicating the content to be performed by the interactive AI model 8ai in cmd, PowerShell, or the like.

The interactive AI model 8ai is activated in response to a call from the task, and conveys an instruction to the worker 9 via the speaker 88 according to the prompt input by the work execution unit 91. Alternatively, an interface screen with the interactive AI model 8ai may be popped up and content of the instruction may be displayed as a sentence to be conveyed to the worker 9. The worker 9 notifies the interactive AI model 8ai of a result of performing an action according to the content of the instruction by inputting a voice using the microphone 89 or inputting a character. The job execution unit 61 transmits the result received from the interactive AI model 8ai to the countermeasure support device 1 as the feedback 7fb.

In the example of FIG. 9, the interactive AI model 8ai issues an instruction “Please unlock evacuation shelter.” to the worker 9 by the task #3, and the worker 9 notifies “Ending of unlocking” as a result of the action. The interactive AI model 8ai issues an instruction “Please check infrastructure and supplies.” to the worker 9 by the task #5, and the worker 9 notifies “Infrastructure is normal. Supplies are insufficient.” as a result of the action. In the countermeasure support device 1, the instruction unit 533 of the WF generation unit 53 detects “Supplies are insufficient.”, which is a part of the result, as a problem to be handled, and the task #10 is added in the system process as described above. Then, the task #10 is executed by the job processing device 2. The worker 9 performs only the notification, and receives an instruction by the next task 7tk without performing work of arranging for the insufficient supplies.

The interactive AI model 8ai issues an instruction “Please install communication terminal.” to the worker 9 by the task #6, and the worker 9 notifies “Installation of communication terminal is completed” as a result of the action. The interactive AI model 8ai issues an instruction “Please make preparations for acceptance of residents.” to the worker 9 by the task #7, and the worker 9 notifies “Preparations for acceptance of residents are completed” as a result of the action. The notification from the worker 9 is received as the result by the related task 7tk, and the received result is transmitted to the countermeasure support device 1 as the feedback 7fb.

In the above description, the work execution unit 91 is an example of a work execution means of the present disclosure. The interactive AI model 8ai is a model trained by machine learning, can have a conversation with the worker 9, and receives an instruction of the task 7tk and information from the worker 9 who has received the instruction. Such an interactive AI model 8ai is an example of a second machine learning model of the present disclosure.

### Countermeasure Support Processing

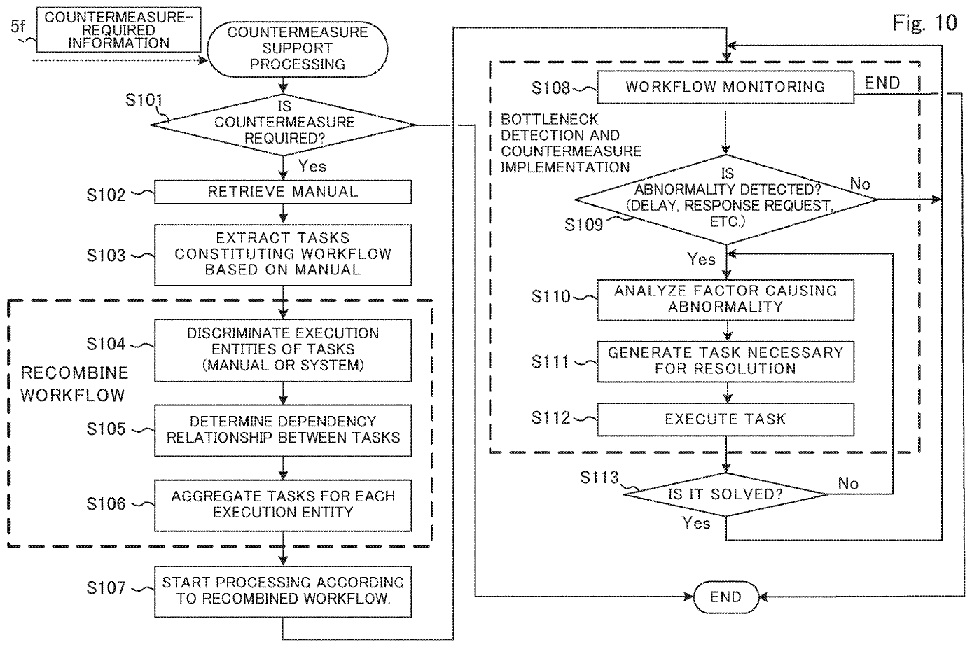

FIG. 10 is a flowchart for explaining countermeasure support processing performed by the countermeasure support device. In FIG. 10, in a case of detecting the countermeasure-required information 5f, the countermeasure support device 1 starts the countermeasure support processing. First, the extraction unit 51 determines whether a countermeasure is necessary based on the countermeasure-required information 5f (step S101). When determining that the countermeasure is unnecessary (NO in step S101), the extraction unit 51 discards the countermeasure-required information 5f, and ends the countermeasure support processing. On the other hand, in a case of determining that the countermeasure is necessary (YES in step S101), the extraction unit 51 retrieves the manual 5m related to the countermeasure-required information 5f from the document storage unit 3 and requests generation of a workflow (step S102). The WF generation unit 53 is notified of the retrieved manual 5m.

In response to the request from the extraction unit 51, the decomposition unit 531 in the WF generation unit 53 extracts the tasks 7tk constituting the workflow based on the manual 5m (step S103). Specifically, the decomposition unit 531 decomposes a job described in the manual 5m into a plurality of tasks 7tk to extract the plurality of tasks 7tk constituting the workflow.

Then, in steps S104 to S106, the workflow is recombined. Specifically, the determination unit 532 discriminates the execution entities 70 for the tasks 7tk, respectively (step S104). In addition, the determination unit 532 determines a solution method for each of the tasks 7tk, and determines the dependency relationship between the tasks based on the determined solution method (step S105). Then, the determination unit 532 aggregates the tasks for each of the execution entities 70 (step S106), and the recombination of the workflow ends. Here, processes in steps S104 and S105 do not depend on the order of steps. Step S104 may be performed after step S105. The prompt 6p describing the processing corresponding to steps S103 to S106 described above may be used to cause the countermeasure AI model 6ai to execute the processing.

Next, the instruction unit 533 starts processing according to the recombined workflow (step S107). Then, in steps S108 to S112, in response to the start of the processing according to the workflow, bottleneck detection for detecting a problem that hinders the execution of the tasks and countermeasure implementation for taking a countermeasure against the problem are performed.

Specifically, the instruction unit 533 controls transmission of each of the tasks based on the dependency relationship from the start of the processing according to the workflow, and performs workflow monitoring for analyzing the feedback 7fb received from each of the tasks (step S109). The instruction unit 533 determines whether a result of the workflow monitoring indicates abnormality (step S109). When the result does not indicate abnormality (NO in step S109), the instruction unit 533 repeats the determination process in step S109 and continues the workflow monitoring to analyze the next feedback 7fb.

On the other hand, in a case where the result indicates abnormality (YES in step S109), the instruction unit 533 analyzes a factor causing the abnormality (step S110). For example, a factor that requires a countermeasure, such as a delay due to shortage of supplies or blocking of a traffic route, is analyzed. Then, the instruction unit 533 generates a new task (hereinafter, referred to as an “additional task”) for resolution (step S111), and executes the additional task (step S112). After a solution method for the additional task is determined and the execution entity 70 of the additional task is determined, the additional task is added to the manual process or the system process. Then, the determined execution entity 70 is instructed to execute the additional task.

The instruction unit 533 determines whether the factor causing the abnormality has been solved by the added task (step S113). That is, it is determined whether the feedback 7fb from the additional task indicates normal termination. In a case where the factor causing the abnormality has been resolved (YES in step S113), the instruction unit 533 returns to step S108 and continues the workflow monitoring. For example, in a case where the factor causing the abnormality is “shortage of supplies”, the task #10 indicating the instruction for transport of supplies is executed, so that the supply of supplies is anticipated, thereby solving this problem. In this case, the instruction unit 533 returns to step S108.

In a case where the factor causing the abnormality has not been resolved yet (NO in step S113), the instruction unit 533 returns to step S110 and repeats the above processing. For example, there is a case where the additional task is the task 7tk that belongs to the manual process and is notified to the worker 9, and during the execution of the additional task, the on-site situation or the like is notified from the interactive AI model 8ai through a conversation with the worker 9. That is, there is a case where a new problem needs to be solved in a state where the factor causing the abnormality has not been resolved. Such a case is included in the case where the factor causing the abnormality has not been resolved yet.

In step S108, in a case where the instruction unit 533 determines that the feedback 7fb indicating the normal termination has been received from all the generated tasks, the countermeasure support processing ends.

### Job Process

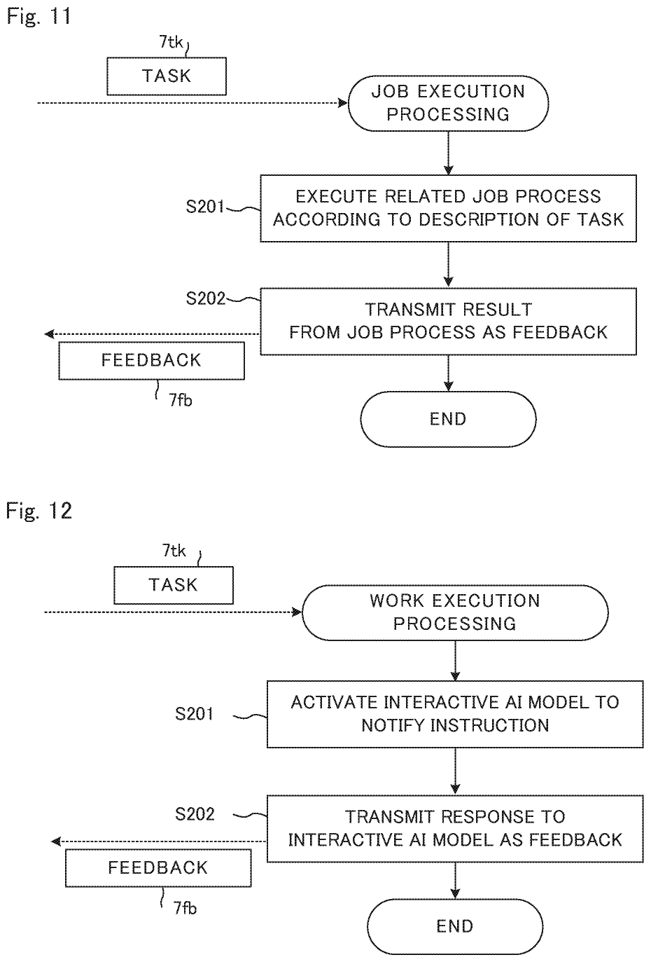

FIG. 11 is a flowchart for describing job execution processing performed by the job processing device. In FIG. 11, in the job processing device 2, in a case where the task 7tk is received from the countermeasure support device 1, the job execution unit 61 starts a job process related to the task 7tk (step S201). The job execution unit 61 executes one or more applications 63 according to a description of the task to perform the job process related to the task 7tk. When receiving a result from the related job process, the job execution unit 61 creates the feedback 7fb for the task 7tk and transmits the feedback 7 fb to the countermeasure support device 1 (step S202). Thereafter, the job execution processing ends. The job execution processing is activated every time the task 7tk is received, and ends in a case where the execution of the application 63 related to the job process is completed. Depending on characteristics of the application 63, there may be two or more pieces of the feedbacks 7fb before the completion of the execution of the application 63.

### Work Execution Processing

FIG. 12 is a flowchart for explaining work execution processing performed by the terminal device. In FIG. 12, in the terminal device 8, in a case where the task 7tk is received from the countermeasure support device 1, the work execution unit 91 starts the work execution processing. The work execution unit 91 activates the interactive AI model 8ai and notifies the worker 9 of an instruction specified by the task 7tk (step S801). Then, in a case where a response from the worker 9 is received, the interactive AI model 8ai transmits content of the response as the feedback 7fb to the countermeasure support device 1 (step S802). The feedback 7fb may include one or more pieces of audio data obtained by recording a conversation with the worker 9 or ambient sound, a text input by the worker 9, image data or moving image data attached by the worker 9, and the like.

### Task Extraction and Discrimination of Execution Entities

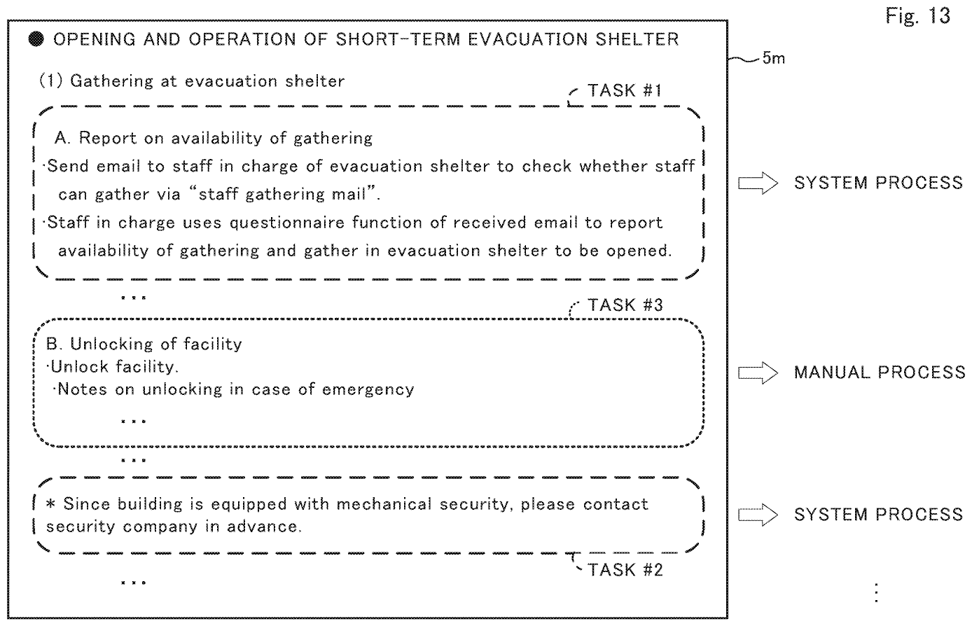

Next, an example of task extraction and discrimination of execution entities performed by the decomposition unit 531 in the WF generation unit 53 of the countermeasure support device 1 will be described. FIG. 13 is a view for explaining an example of the task extraction and the discrimination of execution entities. In the example of FIG. 13, it is assumed that the manual 5m is document data describing a procedure of “opening and operation of short-term evacuation shelter” in the event of a disaster, and a part of the manual 5m is illustrated in the described order.

In the WF generation unit 53, the countermeasure AI model 6ai is caused to analyze the manual 5m using the prompt 6p, and the execution entities 70 of extracted tasks are discriminated and allocated to the related processes. In this example, since the execution entity 70 of a task of “A. Report on availability of gathering” is the system, the task is allocated to this system process. In addition, since the execution entity 70 of a task of “B. Unlocking of facility” is a human, the task is allocated to the manual process. Further, since the execution entity 70 of a task of mark * is the system, the task is allocated to the system process.

By the process generation described below, the task of “A. Report on availability of gathering” is identified as a task #1, the task of “B. Unlocking of facility” is identified as a task #3, and the task of the mark * is identified as a task #2. Here, the task described prior to the task #2 is identified as the task #3 since the execution order of the tasks 7tk is optimized in consideration of cooperation between the plurality of execution entities 70.

### Process Generation

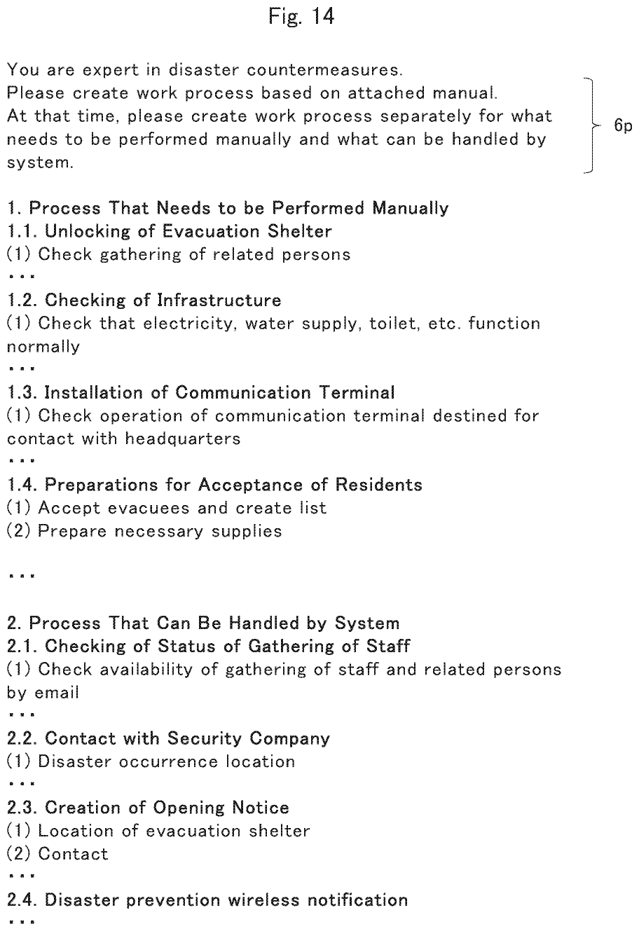

Next, a generation example of a process will be described. FIG. 14 is a view illustrating the prompt and an output example of the countermeasure AI model. In this example, the prompt 6p input to the countermeasure AI model 6ai by the decomposition unit 531 is “You are expert in disaster countermeasures. Please create work process based on attached manual. At that time, create work process separately for what needs to be performed manually and what can be handled by system.”.

In response to the input of the manual 5m and the prompt 6p to the countermeasure AI model 6ai, the retrieval-augmented generation (RAG) retrieves information from an external knowledge base and provides the information to the countermeasure AI model 6ai. The countermeasure AI model 6ai generates a workflow by analyzing the manual 5m and the information provided by the RAG according to the prompt 6p. At that time, the countermeasure AI model 6ai does not convert a procedure of the manual into a workflow as it is, but discriminates a task that requires a human for each of the tasks 7tk and a task that can be executed only by the system according to the prompt 6p. That is, the countermeasure AI model 6ai determines a solution method for each of the tasks, and determines the execution entity 70 based on the determined solution method. Therefore, by the countermeasure AI model 6ai, the tasks 7tk are listed by being divided into items of the process that needs to be manually performed and the process that can be handled by the system based on the result of the discrimination of the execution entities. The tasks 7tk are listed for each of the execution entities 70, and the solution methods are further described for the tasks 7tk, respectively.

Further, the countermeasure AI model 6ai determines the dependency relationship between the plurality of tasks 7tk, discriminates a task that can be performed first without requiring a human, and the like, thereby optimizing the execution order of the tasks 7tk. The solution methods may be analyzed for determining the dependency relationship. In this manner, for example, as illustrated in FIG. 2 as a part of the workflow, the tasks 7tk until the evacuation shelter is opened and the preparations for accepting residents are made are identified, and the execution order is optimized. An administrator or the like may confirm and approve a proposed countermeasure output by the countermeasure AI model 6ai, the execution order, and the like before execution of the workflow.

As described above, according to the process generation of the present disclosure, the countermeasure AI model 6ai decomposes the job described in the manual 5m into the plurality of tasks 7tk. Even if the manual 5m is described without distinguishing between the work of the worker 9 and the processing performed by the job processing device 2, the countermeasure AI model 6ai allocates the plurality of tasks 7tk to the execution entities 70, respectively. As a result, the plurality of tasks 7tk are allocated to the manual process and the system process. As a result, a work load of the worker 9 can be mitigated. In addition, it is possible to mitigate a burden of decision making of the worker 9 under the tension due to the occurrence of the disaster. Further, even in a case where the creation of the manual 5m has not been reviewed for a long time, it is possible to retrieve and supplement recent countermeasure methods by the RAG.

### Bottleneck Detection and Countermeasure Implementation

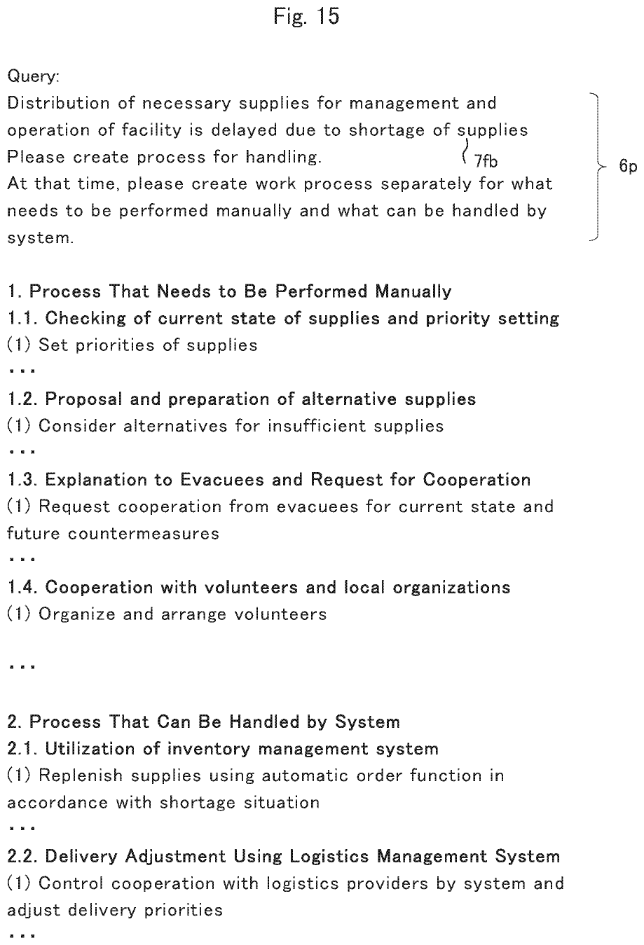

Next, bottleneck detection and countermeasure implementation will be described. FIG. 15 is a view illustrating the prompt and an output example of the countermeasure AI model in a case where a delay is detected. In FIG. 15, in a case where a delay is detected based on analysis of the feedback 7fb, the instruction unit 533 causes the countermeasure AI model 6ai to output a proposed countermeasure using the prompt 6p including content of the feedback 7fb as an input. In this example, the prompt 6p specifies that “Distribution of necessary supplies for management and operation of facility is delayed due to shortage of supplies. Please create process for handling. At that time, create process separately for what needs to be performed manually and what can be handled by system.”. A part of the prompt 6p, that is, “Distribution of necessary supplies for management and operation of facility is delayed due to shortage of supplies.” is a description based on the content of the feedback 7fb (for example, FB #5 for the task #5).

Similarly to the above description, the countermeasure AI model 6ai retrieves a countermeasure against a detected bottleneck from the manual 5m and the RAG, and newly generates the task 7tk. The execution entity 70 is discriminated for the generated task 7tk, and the task 7tk is added to the process related to the discrimination result. The task #10 described above corresponds to this case.

Further, the countermeasure AI model 6ai determines the dependency relationship between the plurality of tasks 7tk in the workflow being implemented, and optimizes the execution order of the tasks 7tk. In this manner, for example, in the workflow being implemented, as illustrated in FIG. 2, in response to the reception of FB #5 for the task #5 in the manual process, the task #10 is added to the system process before the start of the task #8 after the execution of the task #4. Also in this example, the administrator or the like may confirm and approve the proposed countermeasure output by the countermeasure AI model 6ai, the execution order, and the like before execution of the added task 7tk.

As described above, according to the bottleneck detection and the countermeasure implementation of the present disclosure, problems recognized during pieces of work according to the tasks 7tk by any of the workers 9 are aggregated in the countermeasure support device 1 via the interactive AI model 8ai. As a result, a flow of the workflow can be optimized as a whole based on the aggregated various types of information. In addition, the worker 9 may use the interactive AI model 8ai as a main contact means, and the contact means can be simplified.

According to the first example embodiment described above, even in a case where the worker 9 does not sufficiently recognize and train a disaster countermeasure method, the workflow of the disaster countermeasure is created and started by the countermeasure support device 1, so that it is possible to prevent the spread of the damage due to the response delay. Under an urgent situation, even if the worker 9 does not have sufficient knowledge of content and a procedure of work, the worker 9 can perform the work according to the procedure urged by the interactive AI model 8ai using the interactive AI model 8ai, provided in the terminal device 8, as the main contact means. Since work in the system process is discriminated by the countermeasure AI model 6ai and can be promptly executed by the instruction unit 533, working hours of the worker 9 can be shortened. In addition, in a case where a problem occurs during the work, since the countermeasure AI model 6ai reviews the work procedure, it is possible to automatically take a countermeasure against the problem without the work load of the worker 9 and restore the workflow of the disaster countermeasure to an executable state.

### Second Example Embodiment

In the first example embodiment, the countermeasure in the event of the disaster has been described as an example, but the present disclosure is not limited to the countermeasure in the event of the disaster. The technology of the present disclosure can be widely applied, and a work load of the worker 9 can be reduced. For example, the technology of the present disclosure can be applied to a case where a part time job is employed to execute a project in a situation where shortage of manpower becomes serious. Hereinafter, as a second example embodiment, a case of temporarily employing a part-time worker as the worker 9 will be described. Since a hardware configuration and a functional configuration in the second example embodiment are similar to those in the first example embodiment, the description thereof will be omitted.

As the case of temporarily employing the part-time worker, a case of employing a warehouse worker as the temporary part-time worker in a labor shortage, a busy season, or the like is considered. In such a case, the part-time worker does not recognize a work procedure such as a manual. The countermeasure AI model 6ai understands the manual of work and assigns tasks to the part-time worker, a system, a transfer robot, and the like to execute the tasks. In addition, in a case where a work delay occurs, the countermeasure AI model 6ai considers a countermeasure for recovering the delay, and instructs the part-time worker, the system, or the robot to perform a task based on an output result.

It is assumed that the manual 5m stored in the document storage unit 3 describes a procedure of work of a part-time worker. When receiving the countermeasure-required information 5f indicating employment of the part-time worker, the countermeasure support device 1 generates a workflow based on the manual 5m, and the tasks 7tk constituting the workflow are sequentially started. The instruction unit 533 of the WF generation unit 53 transmits the task 7tk to the worker 9 who is the part-time worker, and issues an instruction for the work. Even the part-time worker who does not know content and the procedure of the work can perform the work while having a conversation only with the instruction from the interactive AI model 8ai of the terminal device 8.

When it is detected via the interactive AI model 8ai that the work of the worker 9 (part-time worker) is delayed, a new task for recovering the delay is added by the countermeasure AI model 6ai. By adding the new task, it is possible to support the worker 9 (part-time worker) and recover the delay.

Therefore, according to the second example embodiment, even the part-time worker with insufficient experience and knowledge can perform the given work. When the problem such as the delay occurs, the interactive AI model 8ai determines a task that can be performed by the system or the robot, so that the part-time worker can concentrate on his/her work. In addition, it is possible to mitigate a burden on an employer or other workers in coaching the part-time worker and the like. As described above, the second example embodiment is effective in a case where the warehouse worker is employed as the temporary part-time worker in the labor shortage, the busy season, or the like. It is possible to mitigate the burden on the employer in a case where the part-time worker who is not aware of the work procedure such as the manual is suddenly employed. Even if the work delay occurs, it is possible to quickly recover the delay by bottleneck detection and countermeasure implementation according to the present disclosure.

### Third Example Embodiment

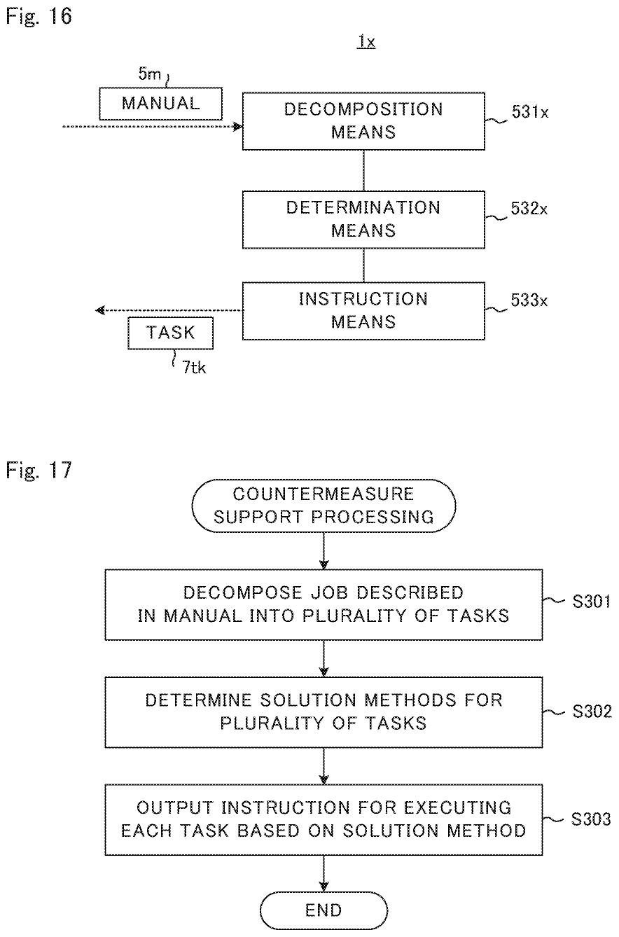

FIG. 16 is a block diagram illustrating a functional configuration of a countermeasure support device according to a third example embodiment. A countermeasure support device 1x includes a decomposition means 531x, a determination means 532x, and an analysis means 533x. A hardware configuration of the countermeasure support device 1x is similar to that of the first example embodiment. The decomposition means 531x, the determination means 532x, and the analysis means 533x are achieved by the processor 12 executing programs, respectively associated to the above-described means.

FIG. 17 is a flowchart of processing performed by the countermeasure support device according to the third example embodiment. In the countermeasure support device 1x, the decomposition means 531x decomposes a job described in the manual 5 m into a plurality of the tasks 7tk (step S301). Next, the determination means 532x determines solution methods for the plurality of tasks, respectively (step S302). Then, instructions for executing the tasks 7tk are output based on the solution methods, respectively (step S303).

As described above, according to the first to third example embodiments, it is possible to extract the plurality of tasks 7tk related to the countermeasure against the occurred event based on the description of the manual 5m and determine the solution method for each of the tasks 7tk. The execution entities 70 of the tasks 7tk may perform the instructed tasks 7tk, respectively. The execution entities 70 may include the worker 9 and the like. In this case, the worker 9 may concentrate on performing the work according to the instructed solution method even if the worker 9 does not have sufficient knowledge and experience of the countermeasure against the event. Therefore, the countermeasure at an early stage at the time of occurrence of the event can be promptly taken, and thus, it is possible to prevent the spread of the damage due to the response delay.

Some or all of the above example embodiments (including the modified examples, the same applies hereinafter) can also be described as the following Supplementary Notes, but are not limited to the following Supplementary Notes.

### Supplementary Note 1

An information processing device including:
a decomposition means configured to decompose a job described in a manual into a plurality of tasks;
a determination means configured to determine a solution method for each of the plurality of tasks; and
an instruction means configured to output an instruction for executing each of the tasks based on the determined solution method.

### Supplementary Note 2

The information processing device according to Supplementary Note 1, wherein, in a case where the determined solution method includes manual work, the instruction means outputs an instruction with respect to a worker in an execution order of the tasks.

### Supplementary Note 3

The information processing device according to Supplementary Note 2, wherein, in a case where the instruction means detects that there is a task that is executable by a system and is implementable independently of the manual work, the instruction means outputs an instruction for executing the task to the system prior to or in parallel with the instruction with respect to the worker.

### Supplementary Note 4

The information processing device according to any one of Supplementary Notes 1 to 3, wherein, in a case where feedback indicating a problem with respect to the output instruction is detected, the instruction means generates one or more new tasks for the problem, and outputs an instruction for executing the one or more new tasks thus generated.

### Supplementary Note 5

The information processing device according to Supplementary Note 4, wherein the one or more new tasks are tasks that are not described in the manual and have not been acquired by the decomposition means.

### Supplementary Note 6

The information processing device according to Supplementary Note 4, further including a first machine learning model that executes, in response to an input of a prompt, one or more of generating the plurality of tasks based on the description of the manual, determining the solution method of each of the tasks, and generating the one or more new tasks.

### Supplementary Note 7

The information processing device according to Supplementary Note 6, wherein the prompt includes a part or entirety of content of the feedback.

### Supplementary Note 8

The information processing device according to Supplementary Note 6, wherein the first machine learning model outputs information related to the prompt by using information retrieved from an external knowledge base by retrieval-augmented generation (RAG).

### Supplementary Note 9

The information processing device according to Supplementary Note 4, wherein
the instruction is made manually, and
the feedback includes a part or entirety of information obtained from a worker who executes the instruction in a case where a second machine learning model included in an output destination of the instruction has a conversation with the worker.

### Supplementary Note 10

The information processing device according to Supplementary Note 3, wherein
the instruction means
detects that there is a task performed by the system in cooperation with the manual work,
further, in a case where a task of work by the system, executed with an execution end of a task of the manual work related to the cooperation as a trigger, is detected, outputs, to the system, an instruction for execution of the task with respect to the system in response to reception of feedback which indicates the execution end and is transmitted from the worker, and
on the other hand, in a case where the task of the manual work, executed with an execution end of the task of work by the system related to the cooperation as a trigger, is detected, outputs an instruction for execution of the task of the manual work by the worker in response to reception of the feedback which indicates the execution end and is output from the system.

### Supplementary Note 11

A terminal device capable of communicating with the information processing device according to Supplementary Note 1, the terminal device including:
a second machine learning model that has a conversation with a worker carrying the terminal device;
a work execution means configured to receive the instruction, inputting the received instruction to the second machine learning model, and transmitting information with respect to the instruction, acquired by the second machine learning model, to the information processing device,
wherein the second machine learning model is a model that is activated in a case of receiving the instruction output from the information processing device, notifies the worker of the instruction, and receives an input of one or more pieces of information of a character, a voice, an image, and a moving image from the worker, and
the work execution means transmits a part or entirety of the information received from the worker by the second machine learning model.

### Supplementary Note 12

A job processing device capable of communicating with the information processing device according to Supplementary Note 1, the job processing device including:
a plurality of applications; and
a job execution means configured to activate one or more of the applications according to the instruction to execute processing in a case of receiving the instruction from the information processing device, and transmitting an execution result to the information processing device.

### Supplementary Note 13

An information processing method including:
decomposing, by a computer, a job described in a manual into a plurality of tasks;
determining, by the computer, a solution method for each of the plurality of tasks; and
outputting, by the computer, an instruction for executing each of the tasks based on the determined solution method.

### Supplementary Note 14

A program for causing a computer to execute processing including:
decomposing a job described in a manual into a plurality of tasks;
determining a solution method for each of the plurality of tasks; and
outputting an instruction for executing each of the tasks based on the determined solution method.

Some or all of the configurations described in Supplementary Notes 2 to 12 dependent on the above-described Supplementary Note 1 can also be dependent on Supplementary Notes 13 and 14 by the same dependency relationship as in Supplementary Notes 2 to 12. Furthermore, some or all of the configurations described as Supplementary Notes can be similarly dependent on not only Supplementary Notes 1, 13, and 14, but also various pieces of hardware and software, and various recording means or systems for recording software without departing from the above-described example embodiments.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

1, 1x Countermeasure support device
2 Job processing device
5m Manual
6ai Countermeasure AI model
8 Terminal device
8ai Interactive AI model
7fb Feedback
7tk Task
51 Extraction unit
53 WF generation unit
70 Execution entity
531, 531x Decomposition unit
532, 532x Determination unit
533, 533x Analysis unit
100 Countermeasure support system

1. An information processing device comprising:
at least one first memory configured to store instructions; and
at least one first processor configured to execute the instructions to:
decompose a job described in a manual into a plurality of tasks;
determine a solution method for each of the plurality of tasks; and
output an instruction for executing each of the tasks based on the determined solution method.

2. The information processing device according to claim 1, wherein, in a case where the determined solution method includes manual work, the first processor outputs an instruction with respect to a worker in an execution order of the tasks.

3. The information processing device according to claim 2, wherein, in a case where the first processor detects that there is a task that is executable by a system and is implementable independently of the manual work, the first processor outputs an instruction for executing the task to the system prior to or in parallel with the instruction with respect to the worker.

4. The information processing device according to any one of claim 1, wherein, in a case where feedback indicating a problem with respect to the output instruction is detected, the first processor generates one or more new tasks for the problem, and outputs an instruction for executing the one or more new tasks thus generated.

5. The information processing device according to claim 4, wherein the one or more new tasks are tasks that are not described in the manual and have not been acquired by the decomposition means.

6. The information processing device according to claim 4, further including a first machine learning model that executes, in response to an input of a prompt, one or more of generating the plurality of tasks based on the description of the manual, determining the solution method of each of the tasks, and generating the one or more new tasks.

7. A terminal device capable of communicating with the information processing device according to claim 1, the terminal device comprising:
at least one second memory configured to store instructions; and
at least one second processor configured to execute the instructions to:
a work execution means configured to receive the instruction, inputting the received instruction to a second machine learning model that has a conversation with a worker carrying the terminal device, and transmitting information with respect to the instruction, acquired by the second machine learning model, to the information processing device,
wherein the second machine learning model is a model that is activated in a case of receiving the instruction output from the information processing device, notifies the worker of the instruction, and receives an input of one or more pieces of information of a character, a voice, an image, and a moving image from the worker, and
the second processor transmits a part or entirety of the information received from the worker by the second machine learning model.

8. A job processing device capable of communicating with the information processing device according to claim 1, the job processing device comprising:
at least one third memory configured to store instructions and a plurality of applications; and
at least one third processor configured to execute the instructions to:
activate one or more of the applications according to the instruction to execute processing in a case of receiving the instruction from the information processing device, and transmitting an execution result to the information processing device.

9. An information processing method comprising:
decomposing, by a computer, a job described in a manual into a plurality of tasks;
determining, by the computer, a solution method for each of the plurality of tasks; and
outputting, by the computer, an instruction for executing each of the tasks based on the determined solution method.

10. A non-transitory computer-readable recording medium storing a program for causing a computer to execute processing comprising:
decomposing a job described in a manual into a plurality of tasks;
determining a solution method for each of the plurality of tasks; and
outputting an instruction for executing each of the tasks based on the determined solution method.
